(19) United States
(12) Patent Application Publication
(10) Pub. No.: US 2008/0263606 A1
(43) Pub. Date: Oct. 23, 2008

(54) High Quality Means to View the Internet and Dvds

(76) Inventor: Michael W. Moore, Spotsylvania, VA (US)

Correspondence Address: LITMAN LAW OFFICES, LTD., P.O. BOX 15035, CRYSTAL CITY STATION, ARLINGTON, VA, 22215-0035, US

(21) Appl. No.: 11/793,133

(22) PCT Filed: Dec. 15, 2005
(86) PCT No.: PCT/US05/45365

§ 371 Date: May 8, 2008

Related U.S. Application Data
(60) Provisional application No. 60/637,796, filed on Dec. 22, 2004.

(51) Int. Cl. H04N 7/173; H04N 5/445

(52) U.S. Cl. 725/89; 725/98; 725/61

(57) ABSTRACT

The system and method for displaying Internet-sourced video programming utilizes a computer system to access and receive a video program from a video programming source. A video processor (126) in communication with the personal computer (100) converts the video program into a video signal for projection, or other video display. In a method for displaying Internet-sourced video programming, a user's personal computer (100) serves as a network client to receive digital video programming from a server (200). In a method for providing Internet-sourced video programming, an Internet receives video programming from numerous video programming providers, and redistributes video programs to network clients. A database (202) contains video programming and programming information received from the video programming providers (204). The server (200) creates a programming menu for display and selection by a network client. On request from the network client, a payment transaction is completed and a video program item is delivered.

### TECHNICAL FIELD

The present invention relates to the distribution and display of digital media. More specifically, the present invention is a system and method for displaying Internet-sourced video programming.

### BACKGROUND ART

In-home entertainment systems include television systems and video monitors used to view television programming, movies and other program materials obtained from video tapes, Digital Video Disks (DVDs), and other sources, such as computer generated graphics, games, and more. As technology enables digital television, and as Internet broadband speeds enable streaming video access by personal computers, the distinctions between television, video monitor, and computer display begin to blur.

Technology advances have also led to various large-screen television and video monitor methods and devices. Direct video projection allows video images to be enlarged for viewing to the scope of a movie theater screen, while indirect projection techniques have been employed in home-oriented large screen devices. Flat panel display technologies, including plasma and Liquid Crystal Display (LCD) devices, provide an increased viewing area for home television and video viewing. Such technologies, however, typically come at the expense of increased costs and increased weight of the associated equipment. Large screen televisions that are based simply on a generally conventional cathode ray tube (CRT) technology are encumbered by the greatest size and weight for a given viewing screen area.

Contemporary personal computers are frequently purchased along with computer programs, such as those referred to as a “media player” that are installed to display video content downloaded from the Internet. While some video content is available from the Internet, video programming for home entertainment is generally delivered as broadcast or cable television, or in the form of a purchased or rented pre-recorded video cassette or DVD. Video cassettes, recordable DVDs, and other recording media are often used to create a copy of video programming obtained through broadcast or cable television. Consumers are thus presented with multiple programming sources and choices.

Along with multiple programming sources and choices, consumers often have multiple video display devices within a single household, generally including several televisions and one or more personal computers having a display monitor. This may present a difficulty in distributing available programming among the several video display devices. A single programming source, such as a DVD player, may be connected to a single video display device, thus limiting the use of the programming source throughout the rest of the household.

Thus, a system and method for displaying Internet-sourced video programming solving the aforementioned problems is desired.

### DISCLOSURE OF THE INVENTION

This disclosure is directed to a system for displaying Internet-sourced video programming. The system includes a computer system with a processor, a main memory for executing program code under the direction of the processor, a storage device for storing data and the program code, and a bus connecting the processor, the main memory, and the storage device. The system also includes a data communications device connected to the bus for connecting a server computer to the Internet, a video processor in communication with the bus, and a video display device in communication with the video processor. A computer program is stored in the storage device and executes in the main memory under the direction of the processor. The computer program includes a means for selecting a video programming source, a means for receiving a video program from the video programming source, a means for causing the video processor to convert the received video program into a video signal compatible with the video display device, and a means for causing the video display device to display a video image according to the video signal onto a viewing surface.

The disclosure is also directed to a method for providing Internet-sourced video programming. The method includes receiving video programming from a plurality of providers and creating a database containing video programs and information about video programs that is available from the providers. In response to a request received from a network client, a programming menu is created for display by the network client that lists programs available for distribution. In response to a purchase request received from the network client, a payment transaction is completed for a requested video program, and the video program is delivered to the network client.

The disclosure is further directed to a method for providing Internet-sourced video programming that includes a multi-step process. The process includes generating a request for service from a network client and receiving the request for service at a web server. A menu of available programming is generated and displayed based on the received request for service. A video program item is selected for viewing from the generated menu of available programming. After the program item is selected, a command is forwarded to the web server requesting the video program item. A payment amount is determined for delivery of the requested video program item based on the command received by the web server, and the requested video program item is delivered from the web server to the network client based on a completed payment transaction covering the payment amount. After the requested video program item is received, it is distributed to a video-viewing device for viewing based on receiving the requested video program item at the network client.

These and other features of the present invention will become readily apparent upon further review of the following specification and drawings.

### BRIEF DESCRIPTION OF THE DRAWINGS

FIG. 1 is a block diagram of a system for displaying Internet-sourced video programming according to the present invention.

FIG. 2 is a block diagram of an Internet server for providing video programming in the system of FIG. 1.

FIG. 3 is a block diagram of a client computer system in a system for displaying Internet-sourced video programming according to the present invention.

FIG. 4 is a block diagram of a video controller in a system for displaying Internet-sourced video programming according to the present invention.

FIG. 5 is a flowchart describing a server-implemented method for providing video programming to the system for displaying Internet-sourced video programming in a method for displaying Internet-sourced video programming according to the present invention.

FIG. 6 is a flowchart describing the general operation of the system for displaying Internet-sourced video programming according to the present invention.

Similar reference characters denote corresponding features consistently throughout the attached drawings.

### BEST MODES FOR CARRYING OUT THE INVENTION

The system and method for displaying Internet-sourced video programming allows presentation and viewing of Internet-sourced video programming under the control of a user's personal computer in a projected large screen format, or other desired format. The system for displaying Internet-sourced video programming utilizes a computer system, such as a typical personal computer, to access the Internet, or another video programming source, to select a video programming source and receive a video program from the source. A video processor in communication with the personal computer is employed to convert the video program into a video signal for projection onto a viewing surface by a video projector in communication with the video processor.

Video programming sources include local sources, such as a DVD player, video cassette player, video game, or the like, or an Internet video source. For displaying Internet-sourced video programming, a user's personal computer serves as a network client to interact with an Internet server, such as a Web server, to receive digital video programs distributed by the server. In a method for providing Internet-sourced video programming, an Internet server computer system is used to receive video programming from numerous video programming providers. A database is created, including the video programming received from the video programming providers, and information about additional available video programming. In response to a request received from a network client, the server creates a programming menu for display by the network client. The programming menu lists video programs available for distribution and provides the network client with means for selecting a video program item for delivery. On receipt of a purchase request from the network client, a payment transaction is completed for a video programming item requested. On completion of the payment transaction, the video program item is delivered by the server to the network client.

An additional aspect of the invention is when a user selects and pays for video programming to view from a remote DVD programming source, the payment amount made by the user to view the DVD programming is credited towards a future DVD purchase the user makes. This purchase can be made directly after viewing the DVD programming.

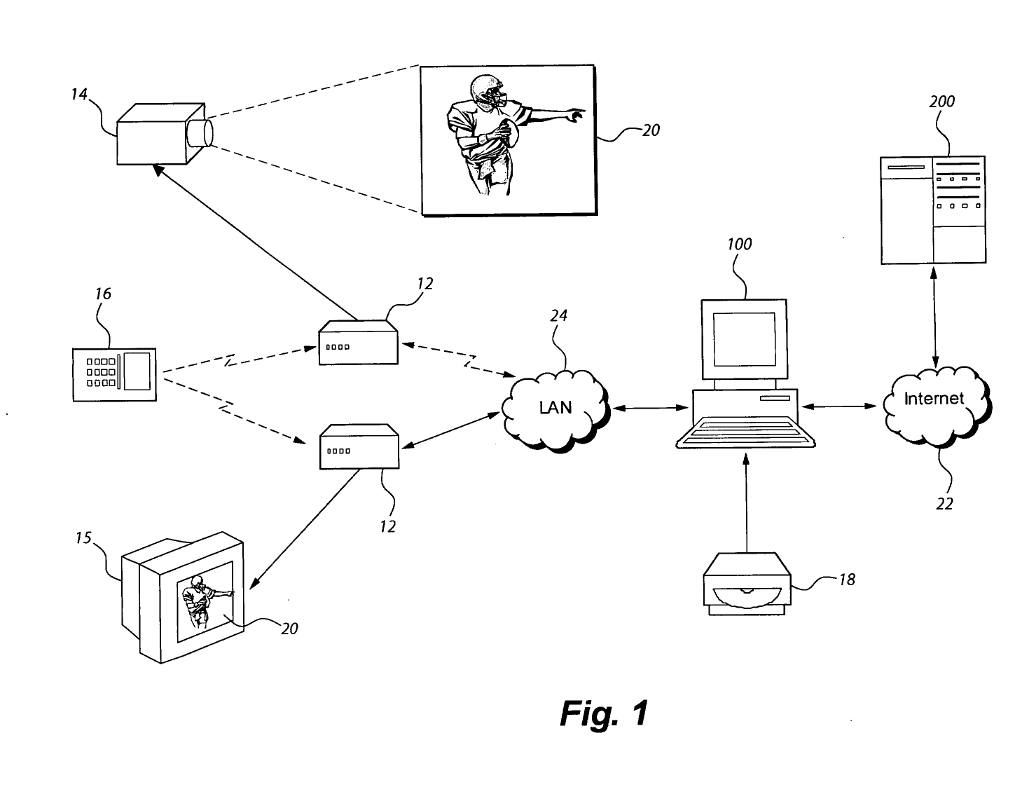

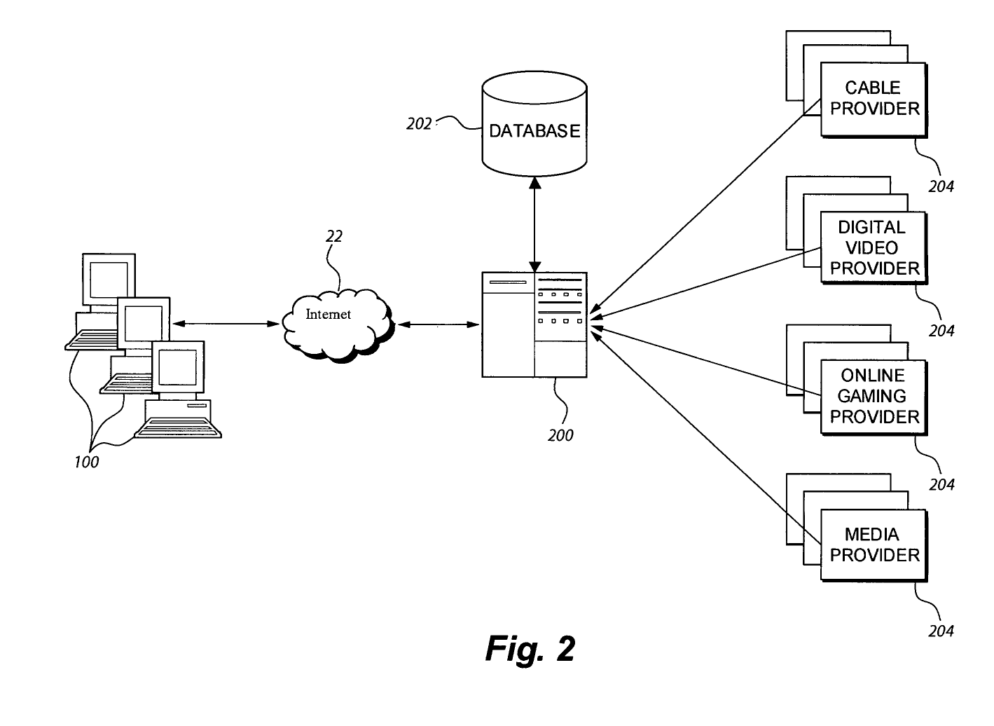

As generally shown in FIGS. 1 and 2, a system for displaying Internet-sourced video programming may comprise a user computer 100, such as a conventional personal computer, in communication with the Internet 22. A video viewing device is connected to the user computer 100. A preferred video viewing device is a video projector 14 capable of projecting a video image 20 onto a viewing surface, although another type of video viewing device, such as a conventional video monitor 15, may be substituted for, or used in conjunction with, the video projector 14.

Video projector 14 is a video image projector capable of projecting a high quality, high definition video image onto a background, such as a home interior wall or a projection screen. Viewing image size is variable, depending on the placement of the video projector 14 relative to the viewing surface and depending on the brightness of the video projector 14. The video projector 14 may be in communication with the user computer 100 through a wired or wireless interface.

Video programming is obtained from an Internet or web server 200, or from a local source 18, such as a digital video disk (DVD) player, video cassette player (VCR), video game equipment, or the like.

The web server 200 is in communication with a variety of video programming sources or providers 204. The video providers 204 may include cable television providers, digital video providers, online video gaming providers, and other media providers. The web server 200 obtains a variety of video programming material from the providers 204, and makes video program items available to network clients, such as the user computer 100.

A database 202 is maintained in communication with the web server 200. Video programming materials may be downloaded by the web server 200 from the providers 204, whereby the web server 200 may maintain a library of program items. Thus, for example, a library of movies may be stored in a digital format for distribution on request to a user computer 100. Alternatively, such as in the case of cable television providers, available program items may be distributed in real-time to user computers 100 according to the programming schedule of the provider. Thus, television viewers may, through Internet redistribution, obtain program items provided by a cable television provider that is located in a different area and not ordinarily available for a conventional cable connection or subscription.

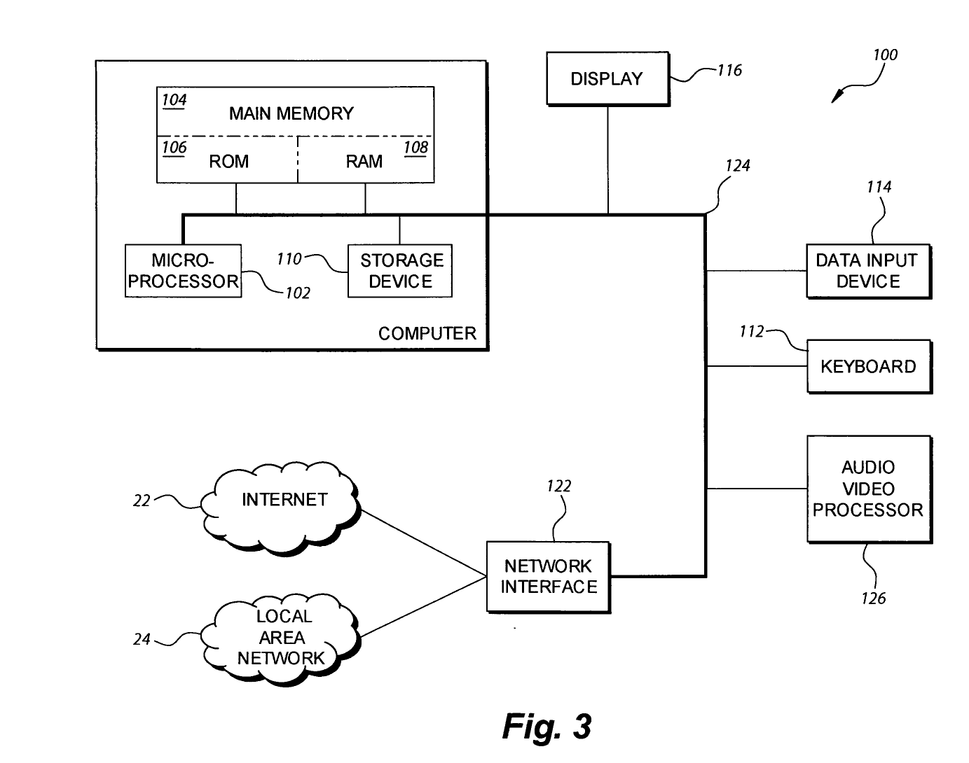

Referring to FIG. 3, the user computer 100 is a general purpose or personal computer of a generally known and common configuration. Such a computer has a microprocessor 102 connected by a bus 124 to an area of main memory 104, comprising both read only memory (ROM) 106, and random access memory (RAM) 108, and a storage device 110, such as a disk storage device, having means for reading a coded set of program instructions on a computer readable medium, which may be loaded into main memory 104 and executed by the microprocessor 102. The user computer 100 has a display device 116, a keyboard 112, and may include one or more additional data input devices 114, such as a mouse, joystick, etc. A network communication interface 122 is provided for serial communications on at least one network or other serial communications link. It is desirable, although not essential, that the user computer 100 be equipped to communicate simultaneously over both the Internet 22 and a local area network (LAN) 24. Additionally, the user computer 100 includes an audio/video processing component 126. The audio/visual processing component 126 performs processing of streaming video received from the Internet 22, and provides inputs for local sources 18, including such video sources as a DVD or video cassette player, a local broadcast television receiver, video game equipment, and others.

Returning to FIG. 1, at least one video viewing device is in communication with the audio/video processing component 126. In the illustrated embodiment, each of the video viewing devices (video projector 14 and monitor 15) communicates with the audio/video processing component 126 via a LAN 24, and through a control unit 12. It can be recognized that, alternatively, a control unit 12 may be directly connected to the user computer 100 using an alternative input/output means. In another alternative, the functions of the control unit 12 may be implemented by the video projector 14, the video projector 14 being in direct wired or wireless communication with the user computer 100. Additionally, a video viewing device may be directly connected to the user computer 100 using an alternative input/output means. The LAN 24, in conjunction with a control unit 12, is employed to allow a video viewing device to be located away from the user computer 100, thereby allowing some flexibility in location of the video viewing device relative to the user computer 100. A wireless LAN 24, or another wireless interconnecting technology, may be employed to increase the flexibility of locating the video viewing device relative to the user computer 100.

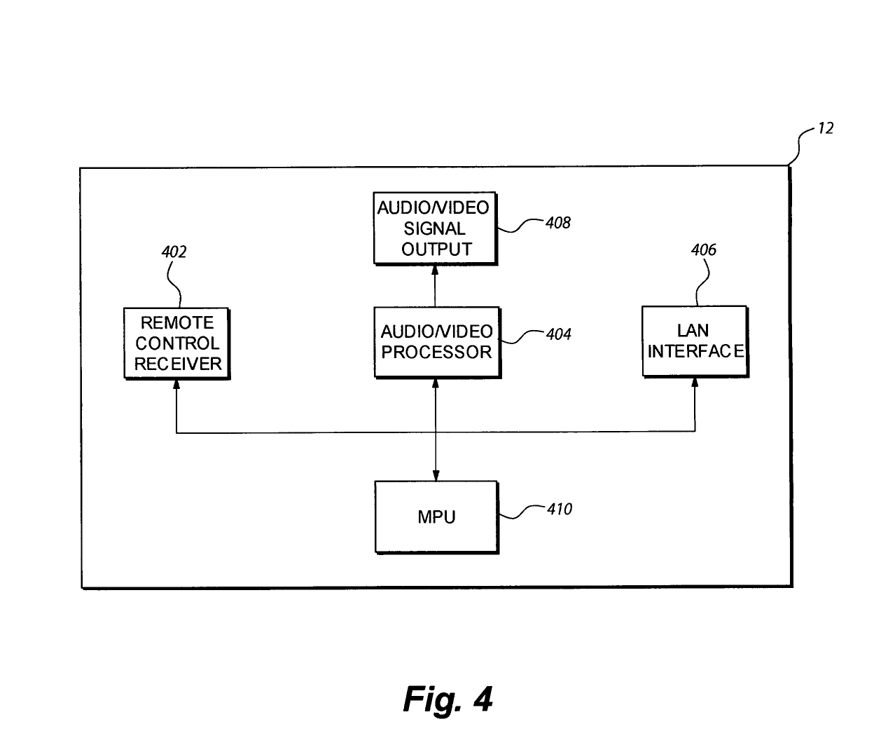

Referring to FIG. 4, a control unit 12 includes an interface for communication with the user computer 100, a remote control receiver 402, and an audio/video signal output 408. A microcomputer controller 410 is employed to operate the remote control receiver and to relay messages and commands between the remote control receiver and the user computer 100. Additionally, the control unit 12 is shown including an audio/video processor 404. With this in mind, it can be appreciated that certain video, or audio/video, processing tasks may be allocated either to the audio/video processing component 126 in the user computer 100, or to the audio/video processor 404 in the control unit 12. A primary video processing task is the conversion of a digital video format, such as streaming digital video, into a video signal for viewing by the video viewing device. Employing a LAN interconnection between the user computer 100 and the control unit 12 suggests that such a conversion is performed within the control unit 12. Conversely, selection of a video source, or conversion of a video signal from a local source 18 for distribution across the LAN 24, is performed by the audio/video processing component 126 in the user computer 100.

Referring back to FIG. 1, a remote control device 16 transmits commands to the control unit 12, allowing a user to control aspects of the display and viewing of video programming. In addition to conventional controls for volume, mute, video quality and attributes, and other controls typically found on a television or cable television remote control, the remote control device 16 facilitates interaction with a menu of video selection options, the menu being displayed on the video viewing device. It can be recognized that an additional function of the audio/video processing component 126 in the user computer 100 is to create menu displays and to mix video menu display signals with video signals distributed to a video viewing device.

A computer program running on the user computer 100 performs interactions with the web server 200 to order and receive video programming materials, and to cause the video programming to be displayed for viewing on a video viewing device. The computer program may be an installed component that is installed on the user computer 100 and stored by storage device 110. Alternatively, the computer program may be a client-side executable component supplied by the web server 200 in response to a specific request.

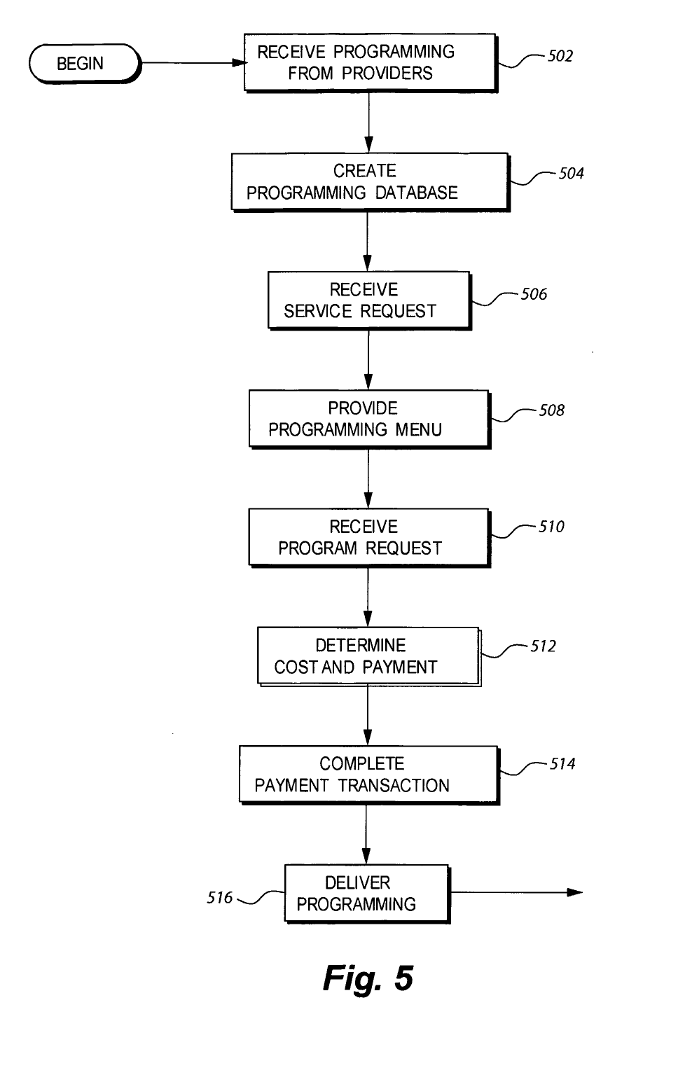

Turning now to FIG. 5, a method for providing video programming to the system for displaying Internet-sourced video programming is described. A web server 200 receives video programming materials from a variety of sources or providers 204 (step 502), for redistribution to user computers 100. The video providers 204 may include cable television providers, digital video providers, online video gaming providers, and other media providers.

The video programming materials are stored in a database 202 maintained by the web server 200 (step 504). The video programming materials include both video program items in digital format, maintained in a library within the database, and program scheduling information describing the video programming that will be available from certain providers 204, such as from cable television providers. Thus, for example, a library of movies may be stored in a digital format for distribution on request to a user computer 100. Alternatively, such as in the case of cable television providers, available program items may be distributed in real-time to user computers 100 according to the programming schedule of the provider.

Video program items are distributed on request and purchase to user computers 100. The web server 200 receives requests for service from user computers 100 (step 506), whereupon the web server 200 generates one or more menus of currently available program items, and delivers the menu to the user computer 100 (step 508). Once a user at a user computer 100 has made a selection to request to purchase and receive a program item, the program request is received by the web server 200 (step 510). On receipt of the program request, a cost for the requested programming is determined (step 512). Additionally, a payment method is determined.

The payment method may be determined by further information exchange with the user computer 100 (and the user), or may be obtained from a predetermined and stored payment method, such as a previously authorized credit card, on-line payment service, or the like. Once the cost and payment method have been determined, a payment transaction is completed (step 514). On completion of the payment transaction, the requested video programming is delivered to the user computer 100. The delivery may involve recalling a video program item from the database and delivering the video program item in a digital streaming video format. Alternatively, the delivery may involve receiving a real-time video program item (such as a program currently being broadcast by a cable television provider), converting the video program item into a digital format, and delivering the video program item in a digital streaming video format.

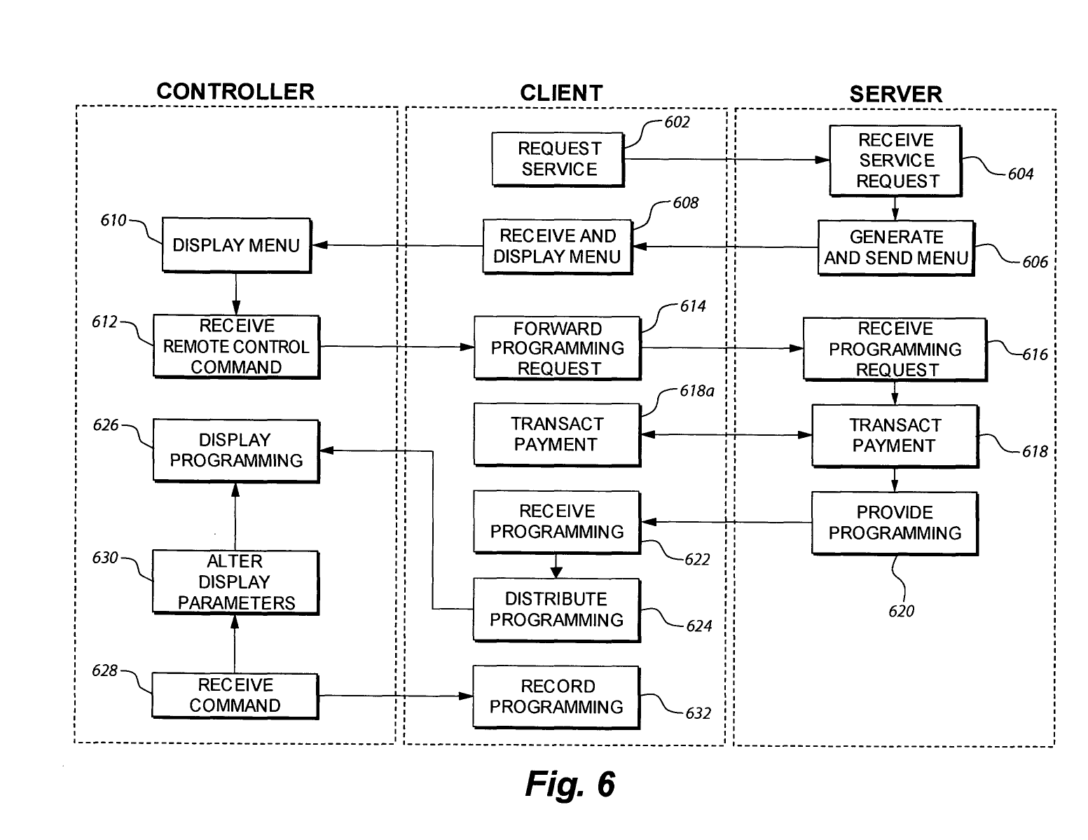

Turning now to FIG. 6, the functionality of the system for displaying Internet-sourced video programming is described. A network client such as user computer 100 generates a request for service (step 602) when a user navigates to a web site providing video programming, and clicks on a URL link to request a service such as a menu of available programming. The web server 200 receives the request (step 604), and generates a menu of available programming, and sends the menu to the user computer 100 (step 606).

The menu is received at the user computer 100, and displayed by an Internet client program (such as an Internet browser) (step 608) or displayed on a video viewing device by the control unit 12 (step 610). The user selects a video program item for viewing using the user computer 100 keyboard 112 and display 116, or using the remote control device 16 in conjunction with the video viewing device and the control unit 12. A command received by the control unit 12 from the remote control device 16 (at 612) is forwarded (at step 614) by the user computer 100 to the web server 200 to request a video program item. Once a programming request is received by the web server 200 (step 616), a payment amount for delivery of the video program item is determined, and payment is transacted (step 618). The payment transaction may be conducted locally by the web server 200, using stored payment information, or by communication with the user computer 100, where the payment transaction is made in part by information stored in the user computer 100 or entered by the user (step 618a). Once the payment transaction is completed, the video program item is delivered from the web server 200 to the user computer 100 (step 620). The delivery may be performed by recalling a video program item from the database and delivering the video program item in a digital streaming video format. Alternatively, the delivery may be performed by receiving a real-time video program item (such as a program currently being broadcast by a cable television provider) at the web server 200, converting the video program item into a digital format, and delivering the video program item to the user computer 100 in a digital streaming video format.

As the streaming video format video program item is received by the user computer (step 622), the user computer distributes the video program item to a video viewing device for viewing (step 624). The streaming video may be converted into a signal for display by the audio/video processing component 126 in the user computer 100. In the embodiment illustrated in FIG. 1, the video program item is sent by the LAN 24 to a control unit 12, and the control unit 12 converts the video program item for display (step 626).

During display of the video program item, the control unit 12 may receive commands from the remote control device 16 (step 628). Commands may be performed by the control unit 12 (such as commands to alter a display or performance parameter, such as volume, mute, video quality and attributes) (step 630) or by the user computer 100 (such as commands to interact with the web server 200, or to begin or end recording of the video program item) (step 632).

Video program item recording (at 632) may be performed by storing the streaming video locally, as received, into a file maintained on the storage device 110 of the user computer 100. It can be recognized that additional functions can be implemented, in conjunction with local storage of the video program item or by the web server 200, to pause the video program item, rewind, fast forward, or record for later playback.

Use of a small and inexpensive video projector 14 allows a user to enjoy the benefits and advantages of a large screen television or video monitor without the expense and size of a large screen television or video monitor. With a LAN, or wireless LAN, or other means for distributing the video programming within the user's home, an additional convenience is realized in that the video projector 14 may be easily and readily relocated throughout the user's premises in a manner that would be inconvenient or difficult with a conventional large screen television or video monitor.

It is to be understood that the present invention is not limited to the embodiment described above, but encompasses any and all embodiments within the scope of the following claims.

I claim:

1. A system for displaying Internet-sourced video programming, comprising:
(a) a computer system having a processor, a main memory for executing program code under the direction of said processor, a storage device for storing data and said program code, and a bus connecting said processor, said main memory, and said storage device;
(b) a data communications device connected to said bus for connecting a server computer to the Internet;
(c) a video processor in communication with said bus;
(d) a video display device in communication with said video processor; and
(e) a computer program stored in said storage device and executing in said main memory under the direction of said processor, said computer program including:
(1) means for selecting a video programming source;
(2) means for receiving a video program from said video programming source;
(3) means for causing said video processor to convert said received video program into a video signal compatible with said video display device; and
(4) means for causing said video display device to display a video image according to said video signal onto a viewing surface.

2. A method for providing Internet-sourced video programming, comprising the steps of:
receiving video programming from a plurality of providers;
creating a database containing video programs and information about video programs available from said providers;
in response to a request received from a network client, creating a programming menu for display by the network client, said programming menu listing programming available for distribution;
in response to a purchase request received from said network client, completing a payment transaction for a requested video program; and
delivering said requested video program to said network client.

3. The method for providing Internet-sourced video programming of claim 2, wherein said plurality of providers is selected from the group consisting of cable television providers, digital video providers, online video gaming providers, and other user-selected media providers.

4. The method for providing Internet-sourced video programming of claim 2, wherein said database contains information selected from the group consisting of: video program items in digital format and program scheduling information describing video programming available from certain providers.

5. The method for providing Internet-sourced video programming of claim 2, wherein said step of completing said payment transaction further includes the step of determining a payment method and a transaction cost.

6. The method for providing Internet-sourced video programming of claim 5, wherein said step of determining said payment method further comprises providing a user an option of selecting between paying by current exchanging of payment information and by accessing predetermined stored payment information.

7. The method for providing Internet-sourced video programming of claim 2, wherein said step of delivering said requested video program to the network client further comprises providing the client an option of selecting between delivery by:
recalling a video program item from the database and delivering the video program item in a digital streaming video format, and
receiving a real-time or broadcast video program item, converting said real-time or broadcast video program item into a digital format, and delivering said converted real-time or broadcast video program item in a digital streaming video format.

8. A method for providing Internet-sourced video programming, comprising the steps of:
generating a request for service from a network client;
receiving said request for service at a web server and generating a menu of available programming based on receiving said request for service;
displaying said generated menu of available programming;
selecting a video program item from said generated menu of available programming for viewing;
forwarding a command from said step of selecting said video program to said web server to request said video program item;
determining a payment amount for delivery of said requested video program item base on receiving said command by said web server;
delivering said requested video program item from said web server to said network client based on a completed payment transaction covering said payment amount; and
distributing said requested video program item to a video viewing device for viewing based on receiving said requested video program item at said network client.

9. The method for providing Internet-sourced video programming of claim 8, further comprising the step of completing the payment transaction by using stored payment information at said web server or by using stored payment information at said network client.

10. The method for providing Internet-sourced video programming of claim 8, further including the step of receiving commands from a remote control device during distribution of said requested video program item to alter a display or a performance parameter of said requested video program item.

11. The method for providing Internet-sourced video programming of claim 10, further including the step of receiving commands from said remote control device during distribution of said requested video program item to begin or end recording of said requested video program item.

12. The method for providing Internet-sourced video programming of claim 8, further including the step of receiving commands from a computer to interact with said web server.

13. The method for providing Internet-sourced video programming of claim 8, further including the step of storing said requested video program into a file on a storage device in said network client.

14. The method for providing Internet-sourced video programming of claim 13, further including the step of performing at least one function selected from the group of pausing, rewinding, fast forwarding and recording said stored video program.
